(19) United States
(12) Patent Application Publication
(10) Pub. No.: US 2018/0039122 A1
(43) Pub. Date: Feb. 8, 2018

(54) METHOD FOR MANUFACTURING PATTERNED ELECTRODE AND LIQUID CRYSTAL DISPLAY PANEL AND MANUFACTURING METHOD THEREOF

(71) Applicant: Shenzhen China Star Optoelectronics Technology Co. Ltd., Shenzhen, Guangdong (CN)

(72) Inventors: Yungjui Lee, Shenzhen City (CN); Haijun Wang, Shenzhen City (CN); Tao Hu, Shenzhen City (CN)

(21) Appl. No.: 14/914,644

(22) PCT Filed: Dec. 23, 2015
(86) PCT No.: PCT/CN2015/098508

§ 371 Date: Feb. 26, 2016

(30) Foreign Application Priority Data
Nov. 20, 2015 (CN) 201510818445.5

(51) Int. Cl. G02F 1/1343

(52) U.S. Cl. CPC G02F 1/13439; G02F 2201/121; G02F 2201/123; G02F 2202/16; G02F 2203/01

(57) ABSTRACT

The present invention provides a method for manufacturing a patterned electrode and a liquid crystal display panel and a manufacturing method thereof. The method for manufacturing a patterned electrode includes the following steps: Step 1: mixing a graphene aqueous solution and a PEDOT:PSS solution at a predetermined ratio to form a graphene/PEDOT:PSS mixture solution; Step 2: mixing the graphene/PEDOT:PSS mixture solution and photoresist at a predetermined ratio, followed by stirring, to form graphene/PEDOT:PSS photoresist that has electrical conduction capability; Step 3: providing a substrate and coating the graphene/PEDOT:PSS photoresist formed in Step 2 on the substrate, followed by exposure, development, and baking to form a patterned electrode. Compared to a conventional process of manufacturing an ITO electrode, the present invention can simplify the manufacturing process of a patterned electrode and lower down the manufacturing cost of the patterned electrode.

### BACKGROUND OF THE INVENTION

### 1. Field of the Invention

The present invention relates to the field of display technology, and in particular to a method for manufacturing a patterned electrode and a liquid crystal display panel and a manufacturing method thereof.

### 2. The Related Arts

Liquid crystal displays (LCDs) are one of the most widely used flat panel displays. A liquid crystal display panel is a key constituent part of an LCD. The liquid crystal display panel is generally composed of a color filter (CF) substrate, a thin-film transistor (TFT) array substrate, and a liquid crystal layer arranged between the two substrates. Generally, the array substrate and the CF substrate are respectively provided with a pixel electrode and a common electrode. When an electrical voltage is applied between the pixel electrode and the common electrode to induce an electric field, the electric field determines the orientation of liquid crystal molecules and thus adjusting polarization of light in the liquid crystal layer, making the liquid crystal panel displaying an image.

Based the operation modes of liquid crystal, LCDs are classified as phase change (PC), twisted nematic (TN), super twisted nematic (STN), vertical alignment (VA), in plane switching (IPS) type, among which the VA type of LCD has a relatively high contrast and is widely used in large-sized panels. However, since the VA liquid crystal panel uses liquid crystal showing the characteristics of vertical rotation and molecules of such liquid crystal have a great difference in birefringence, a relatively severe issue of color shifting of the entire panel may result.

Heretofore, the so-called multi-domain vertical alignment (MVA) is adopted to overcome the above-described color shifting issue. In other words, a sub-pixel zone is divided into multiple domains and liquid crystal tilts in a different direction for each domain when a voltage is applied thereby reducing the influence of color shifting and improving the perception of vision. Various ways may be adopted to achieve MVA, one being that the pixel electrode located at one side is divided into multiple areas with the portions of the pixel electrode in these areas formed as a pattern including pixel electrode branches extending in a different direction and spaced by slits, while the common electrode that is located at an opposite side is formed as a continuous, non-interrupted, planar electrode having a uniform thickness. Due the unique pattern of the pixel electrode, the inclined electric fields generated thereby may guide the liquid crystal molecules in different areas to tilt in different directions. In this way of MVA, the pixel electrode and the common electrode are generally made of a material comprising indium tin oxide (ITO), wherein a process of manufacturing the patterned pixel electrode requires first sputtering a thin ITO film through chemical vapor deposition (CVD) or physical vapor deposition (PVD) and then coating a layer of photoresist on the ITO, followed by applying a shielding mask having a specific configuration to subject the photoresist to exposure and then subjecting the photoresist to development, and then, etching the ITO film to form a pattern that is identical to that of the photoresist, and finally, peeling off the photoresist. This forms an ITO electrode having a specific pattern.

Contemporarily, the techniques used to form the ITO film are PVD and CVD. These techniques, although quite mature, require a relatively high manufacturing cost. Further, indium contained in ITO is a rare metal and the cost is continuously increased with the amount thereof being consumed so that the application of ITO for industrial use is constrained. Further, due to the requirement of high resolution, in forming a special pattern of ITO, it needs coating of positive photoresist. The positive photoresist has a higher cost and thus an increase of the cost for manufacturing operation results.

### SUMMARY OF THE INVENTION

An object of the present invention is to provide a method for manufacturing a patterned electrode, which simplifies the manufacturing operation of the patterned electrode and reduces the manufacturing cost of the patterned electrode.

Another object of the present invention is to provide a manufacturing method of a liquid crystal display panel, which simplifies the manufacturing operation of a patterned electrode of the liquid crystal display panel and reduces the manufacturing costs of the electrode and the liquid crystal display panel for improving product competition power.

A further object of the present invention is to provide a liquid crystal display panel, which reduces the cost of a liquid crystal display panel and improves product competition power.

To achieve the above objects, the present invention provides a method for manufacturing a patterned electrode, which comprises the following steps:

(1) providing a graphene aqueous solution and a PEDOT:PSS (poly(3,4-ethylenedioxythiophene):polystyrene sulfonate) solution and mixing the graphene aqueous solution and the PEDOT:PSS solution at a predetermined ratio to form a graphene/PEDOT:PSS mixture solution;

(2) providing photoresist and mixing the graphene/PEDOT:PSS mixture solution and the photoresist at a predetermined ratio, followed by stirring, to form graphene/PEDOT:PSS photoresist that has electrical conduction capability; and

(3) providing a substrate and coating the graphene/PEDOT:PSS photoresist formed in step (2) on the substrate, and using a mask having a predetermined shape to subject the graphene/PEDOT:PSS photoresist coated on the substrate to exposure, followed by development with a developing solution and baking to form a patterned electrode.

In step (1), a mass percentage of graphene contained in the graphene aqueous solution is 1 wt %-99 wt % and a mass percentage of PEDOT:PSS contained in the PEDOT:PSS solution is 1 wt %-99 wt %; and the graphene aqueous solution and the PEDOT:PSS solution are mixed at a mass ratio of 1:5-1:100.

In step (2), the graphene/PEDOT:PSS mixture solution and the photoresist are mixed at a mass ratio of 1:1-1:50; and the photoresist comprises a photosensitizer, resin, and a solvent, wherein the photosensitizer, the resin, and the solvent have a mass ratio of 5:20:75.

In step (3), coating the graphene/PEDOT:PSS photoresist is achieved with an operation of slit coating, spin coating, or spray coating; the developing solution comprises a potassium hydroxide solution and a mass percentage of potassium hydroxide in the potassium hydroxide solution is 0.04 wt %; and baking temperature is 230° C. and baking time is 10 min.

The present invention also provides a manufacturing method of a liquid crystal display panel, which comprises the following steps:

(1) providing a graphene aqueous solution and a PEDOT:PSS solution and mixing the graphene aqueous solution and the PEDOT:PSS solution at a predetermined ratio to form a graphene/PEDOT:PSS mixture solution;

(2) providing photoresist and mixing the graphene/PEDOT:PSS mixture solution and the photoresist at a predetermined ratio, followed by stirring, to form graphene/PEDOT:PSS photoresist that has electrical conduction capability;

(3) providing a color filter substrate, coating the graphene/PEDOT:PSS mixture solution formed in step (1) on the color filter substrate in order to form a first electrode on the color filter substrate after baking, wherein the first electrode is a complete electrode covering an entire surface and having a uniform thickness and is continuous and non-interrupted, and forming a first liquid crystal alignment layer on the first electrode;

(4) providing an array substrate and coating the graphene/PEDOT:PSS photoresist formed in step (2) on the array substrate, using a mask having a predetermined shape to subject the graphene/PEDOT:PSS photoresist coated on the array substrate to exposure, followed by development with a developing solution and baking to form a patterned second electrode, and forming a second liquid crystal alignment layer on the second electrode; and

(5) assembling the color filter substrate and the array substrate together to have the first liquid crystal alignment layer and the second liquid crystal alignment layer opposite to each other and filling liquid crystal between the first liquid crystal alignment layer and the second liquid crystal alignment layer to form a liquid crystal layer so as to form a liquid crystal display panel.

In step (1), a mass percentage of graphene contained in the graphene aqueous solution is 1 wt %-99 wt % and a mass percentage of PEDOT:PSS contained in the PEDOT:PSS solution is 1 wt %-99 wt %; and the graphene aqueous solution and the PEDOT:PSS solution are mixed at a mass ratio of 1:5-1:100.

In step (2), the graphene/PEDOT:PSS mixture solution and the photoresist are mixed at a mass ratio of 1:1-1:50; and the photoresist comprises a photosensitizer, resin, and a solvent, wherein the photosensitizer, the resin, and the solvent have a mass ratio of 5:20:75.

In step (3), coating the graphene/PEDOT:PSS mixture solution is achieved with a spin coating process and the spin coating process comprises: first conducting spin coating at a rotational speed of 500 rpm for 10 s and then conducting spin coating at a rotational speed of 800 rpm for 20 s; and baking temperature is 120° C. and baking time is 10 min.

In step (4), coating the graphene/PEDOT:PSS photoresist is achieved with an operation of slit coating, spin coating, or spray coating; the developing solution comprises a potassium hydroxide solution and a mass percentage of potassium hydroxide in the potassium hydroxide solution is 0.04 wt %; and baking temperature is 230° C. and baking time is 10 min.

The present invention further provides a liquid crystal display panel, which comprises: a color filter substrate, an array substrate opposite to the color filter substrate, a first electrode arranged on one side of the color filter substrate that is adjacent to the array substrate, a first liquid crystal alignment layer arranged on the first electrode, a second electrode formed on the array substrate, a second liquid crystal alignment layer arranged on the second electrode, and a liquid crystal layer interposed between the first and second liquid crystal alignment layer;
wherein the second electrode is a patterned electrode and the first electrode is a complete electrode covering an entire surface and having a uniform thickness and is continuous and non-interrupted;
the first electrode is formed of a material comprising a mixture of graphene and PEDOT:PSS; and
the second electrode is formed of a material comprising a mixture of graphene, PEDOT:PSS, and photoresist.

The efficacy of the present invention is that the present invention provides a method for manufacturing a patterned electrode. The method mixes graphene, PEDOT:PSS, and photoresist together to form graphene/PEDOT:PSS photoresist having electrical conduction capability and using the graphene/PEDOT:PSS photoresist having electrical conduction capability to form a patterned electrode. Compared to the existing techniques that uses an ITO material, the material costs of graphene and PEDOT:PSS are greatly reduced. Further, by using the graphene/PEDOT:PSS photoresist that is electrically conductive to directly conduct a patterning operation, compared to the existing techniques, an operation of coating positive photoresist is saved so that the manufacturing time and manufacturing cost can be both reduced. Further, the present invention also provides a manufacturing method of a liquid crystal display panel. The method uses a graphene/PEDOT:PSS mixture solution to make a complete first electrode covering an entire surface and uses a graphene/PEDOT:PSS photoresist that is electrically conductive to make a patterned second electrode, so as to reduce manufacturing cost, increase manufacturing efficiency, and achieve multi-domain alignment. The present invention further provides a liquid crystal display panel. The liquid crystal display panel may achieve multi-domain alignment, reduce the cost of a liquid crystal display panel, and increase product competition power.

For better understanding of the features and technical contents of the present invention, reference will be made to the following detailed description of the present invention and the attached drawings. However, the drawings are provided for the purposes of reference and illustration and are not intended to impose limitations to the present invention.

### BRIEF DESCRIPTION OF THE DRAWINGS

The technical solution, as well as other beneficial advantages, of the present invention will be apparent from the following detailed description of embodiments of the present invention, with reference to the attached drawing. In the drawing:

FIG. 1 is a flow chart illustrating a method for manufacturing a patterned electrode according to the present invention;

FIG. 2 is a flow chart illustrating a manufacturing method of a liquid crystal display panel according to the present invention; and

FIG. 3 is a schematic view illustrating a structure of a liquid crystal display panel according to the present invention.

### DETAILED DESCRIPTION OF THE PREFERRED EMBODIMENTS

To further expound the technical solution adopted in the present invention and the advantages thereof, a detailed description is given to a preferred embodiment of the present invention and the attached drawings.

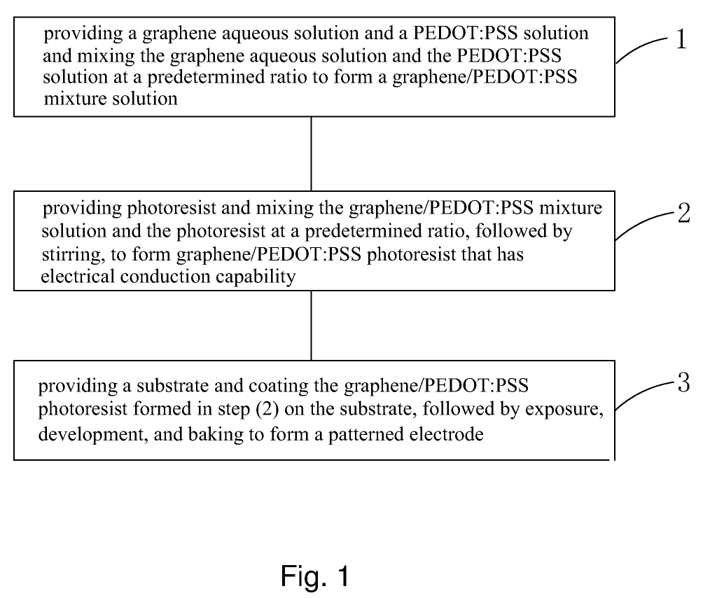

Referring to FIG. 1, firstly, the present invention provides a method for manufacturing a patterned electrode, which comprises the following steps:

Step 1: providing a graphene aqueous solution and a PEDOT:PSS (poly(3,4-ethylenedioxythiophene):polystyrene sulfonate) solution and mixing the graphene aqueous solution and the PEDOT:PSS solution at a predetermined ratio to form a graphene/PEDOT:PSS mixture solution.

Specifically, the mass percentage of graphene contained in the graphene aqueous solution is 1 wt %-99 wt %, and preferably 50 wt %.

Specifically, the mass percentage of PEDOT:PSS contained in the PEDOT:PSS solution is 1 wt %-99 wt %, and preferably 50 wt %.

Specifically, the graphene aqueous solution and the PEDOT:PSS solution are mixed at a mass ratio of 1:5-1:100; and preferably, the graphene aqueous solution and the PEDOT:PSS solution are mixed at a mass ratio of 1:10.

Specifically, ultrasonic oscillation is applied to mix the graphene aqueous solution and the PEDOT:PSS solution and ultrasonic power of the ultrasonic oscillation is 300 W and the time period of the ultrasonic operation is 10 min.

The present invention uses graphene and PEDOT:PSS to make an electrode and compared to the existing techniques that uses an ITO material, material costs of graphene and PEDOT:PSS are relatively low so that the manufacturing cost of the electrode can be reduced.

Step 2: providing photoresist and mixing the graphene/PEDOT:PSS mixture solution and the photoresist at a predetermined ratio, followed by stirring, to form graphene/PEDOT:PSS photoresist that has electrical conduction capability.

Specifically, in Step 2, the graphene/PEDOT:PSS mixture solution and the photoresist are mixed at a mass ratio of 1:1-1:50; and, preferably, in Step 2, the graphene/PEDOT:PSS mixture solution and the photoresist are mixed at a mass ratio of 2:3.

Specifically, the photoresist comprises a photosensitizer, resin, and a solvent, wherein the photosensitizer, the resin, and the solvent have a mass ratio of 5:20:75 and the photoresist can be selected from various types of photoresist including positive photoresist and negative photoresist.

Step 3: providing a substrate and coating the graphene/PEDOT:PSS photoresist formed in Step 2 on the substrate, and using a mask having a predetermined shape to subject the graphene/PEDOT:PSS photoresist coated on the substrate to exposure, followed by development with a developing solution and baking to form a patterned electrode.

Specifically, in Step 3, coating the graphene/PEDOT:PSS photoresist is achieved with an operation of slit coating, spin coating, or spray coating; the developing solution comprises a potassium hydroxide (KOH) solution and in the potassium hydroxide solution, the mass percentage of potassium hydroxide is 0.04 wt %; the baking temperature is 230° C. and baking time is 10 min. By using the graphene/PEDOT:PSS photoresist that is electrically conductive to directly conduct a patterning operation, compared to the existing techniques, an operation of coating positive photoresist is saved so that the manufacturing time and manufacturing cost can be both reduced.

It is noted here that the patterned electrode can be a pixel electrode used in the MVA technology, wherein the pixel electrode is divided into multiple areas and the pixel electrode in each of the areas comprises a pattern of pixel electrode branches extending in a direction and spaced by slits, such as a pixel electrode in the form of a star (*)-shaped configuration.

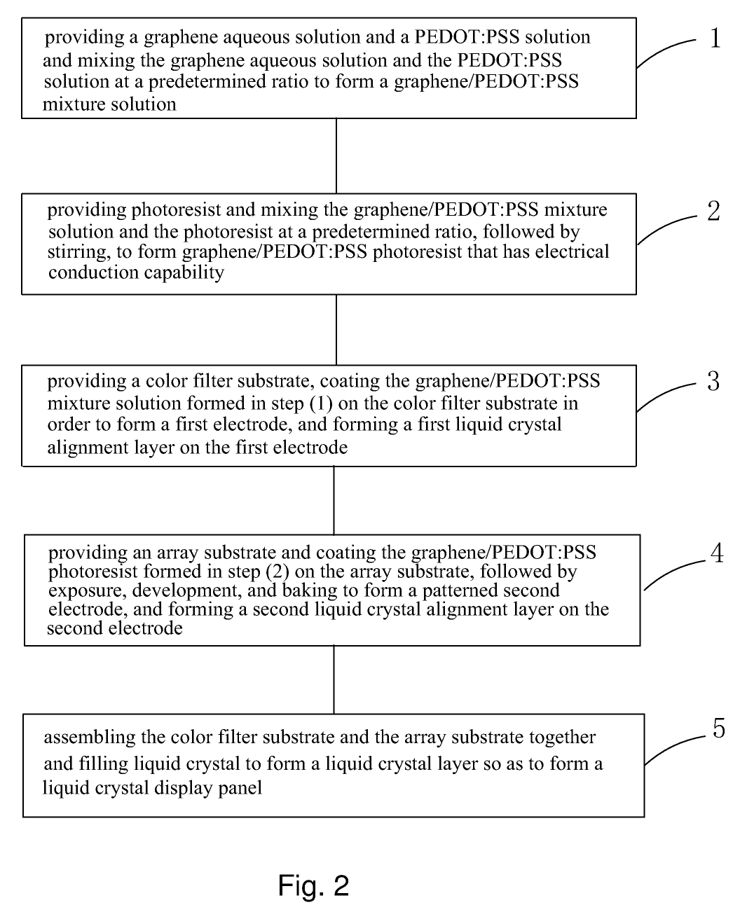

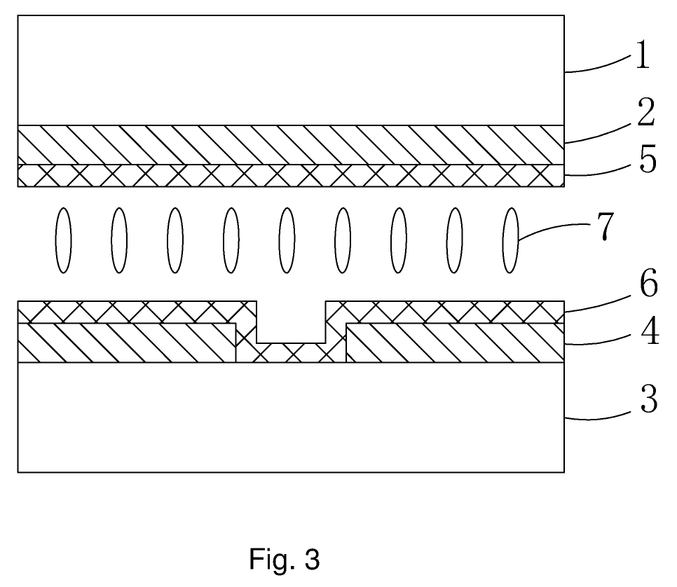

Referring to FIGS. 2 and 3, based on the above-described method for manufacturing a patterned electrode, the present invention also provides a manufacturing method of a liquid crystal display panel, which comprises the following steps:

Step 1: providing a graphene aqueous solution and a PEDOT:PSS solution and mixing the graphene aqueous solution and the PEDOT:PSS solution at a predetermined ratio to form a graphene/PEDOT:PSS mixture solution.

Specifically, the mass percentage of graphene contained in the graphene aqueous solution is 1 wt %-99 wt %, and preferably 50 wt %.

Specifically, the mass percentage of PEDOT:PSS contained in the PEDOT:PSS solution is 1 wt %-99 wt %, and preferably 50 wt %.

Specifically, the graphene aqueous solution and the PEDOT:PSS solution are mixed at a mass ratio of 1:5-1:100; and preferably, the graphene aqueous solution and the PEDOT:PSS solution are mixed at a mass ratio of 1:10.

Specifically, ultrasonic oscillation is applied to mix the graphene aqueous solution and the PEDOT:PSS solution and ultrasonic power of the ultrasonic oscillation is 300 W and the time period of the ultrasonic operation is 10 min.

The present invention uses graphene and PEDOT:PSS to make an electrode and compared to the existing techniques that uses an ITO material, material costs of graphene and PEDOT:PSS are relatively low.

Step 2: providing photoresist and mixing the graphene/PEDOT:PSS mixture solution and the photoresist at a predetermined ratio, followed by stirring, to form graphene/PEDOT:PSS photoresist that has electrical conduction capability.

Specifically, in Step 2, the graphene/PEDOT:PSS mixture solution and the photoresist are mixed at a mass ratio of 1:1-1:50; and, preferably, in Step 2, the graphene/PEDOT:PSS mixture solution and the photoresist are mixed at a mass ratio of 2:3.

Specifically, the photoresist comprises a photosensitizer, resin, and a solvent, wherein the photosensitizer, the resin, and the solvent have a mass ratio of 5:20:75 and the photoresist can be selected from various types of photoresist including positive photoresist and negative photoresist.

Step 3: providing a color filter substrate 1, coating the graphene/PEDOT:PSS mixture solution formed in Step 1 on the color filter substrate 1 in order to form a first electrode 2 on the color filter substrate 1 after baking, wherein the first electrode 2 is a complete electrode covering an entire surface and having a uniform thickness and is continuous and non-interrupted, and forming a first liquid crystal alignment layer 5 on the first electrode 2.

Specifically, in Step 3, coating the graphene/PEDOT:PSS mixture solution is achieved with a spin coating process and the spin coating process comprises: first conducting spin coating at a rotational speed of 500 rpm for 10 s and then conducting spin coating at a rotational speed of 800 rpm for 20 s. The baking temperature is 120° C. and baking time is 10 min. The first electrode 2 can be a common electrode of a liquid crystal display panel. The color filter substrate may adopt a known structure and no detailed description will be provided herein.

Step 4: providing an array substrate 3 and coating the graphene/PEDOT:PSS photoresist formed in Step 2 on the array substrate 3, using a mask having a predetermined shape to subject the graphene/PEDOT:PSS photoresist coated on the array substrate 3 to exposure, followed by development with a developing solution and baking to form a patterned second electrode 4, and forming a second liquid crystal alignment layer 6 on the second electrode 4.

Specifically, in Step 4, coating the graphene/PEDOT:PSS photoresist is achieved with an operation of slit coating, spin coating, or spray coating; the developing solution comprises a potassium hydroxide solution and in the potassium hydroxide solution, the mass percentage of potassium hydroxide is 0.04 wt %; the baking temperature is 230° C. and baking time is 10 min. The second electrode 4 is a patterned pixel electrode. The pixel electrode is divided into multiple areas and the pixel electrode in each of the areas comprises a pattern of pixel electrode branches extending in a direction and spaced by slits, such as a pixel electrode in the form of a star (*)-shaped configuration. The array substrate may adopt a known structure and no detailed description will be provided herein.

Step 5: assembling the color filter substrate 1 and the array substrate 3 together to have the first liquid crystal alignment layer 5 and the second liquid crystal alignment layer 6 opposite to each other and filling liquid crystal between the first liquid crystal alignment layer 5 and the second liquid crystal alignment layer 6 to form a liquid crystal layer 7 so as to form a liquid crystal display panel.

Particularly, the above-described manufacturing method of a liquid crystal display panel uses a graphene/PEDOT:PSS mixture solution to make a planar first electrode and uses a graphene/PEDOT:PSS photoresist that is electrically conductive to make a patterned second electrode, and compared to the existing techniques, it is possible to simplify the manufacturing operation, reduce the manufacturing cost, and increase the manufacturing efficiency, while achieving multi-domain alignment.

Referring to FIG. 3, the present invention also provides a liquid crystal display panel, which comprises: a color filter substrate 1, an array substrate 3 opposite to the color filter substrate 1, a first electrode 2 arranged on one side of the color filter substrate 1 that is adjacent to the array substrate 3, a first liquid crystal alignment layer 5 arranged on the first electrode 2, a second electrode 4 formed on the array substrate 3, a second liquid crystal alignment layer 6 arranged on the second electrode 4, and a liquid crystal layer 7 interposed between the first and second liquid crystal alignment layer 5, 6.

The second electrode 4 is a patterned electrode, while the first electrode 2 is a complete electrode covering an entire surface and having a uniform thickness and is continuous and non-interrupted.

The first electrode 2 is formed of a material comprising a mixture of graphene and PEDOT:PSS.

The second electrode 4 is formed of a material comprising a mixture of graphene, PEDOT:PSS, and photoresist.

Particularly, the second electrode 4 is formed by coating a mixture comprising graphene, PEDOT:PSS, and photoresist on the array substrate, followed by operations of exposure, development, and baking. The second electrode 4 is a patterned pixel electrode. The pixel electrode is divided into multiple areas and the pixel electrode in each of the areas comprises a pattern of pixel electrode branches extending in a direction and spaced by slits, such as a pixel electrode in the form of a star (*)-shaped configuration. The array substrate and the color filter substrate may adopt known structures and no detailed description will be provided herein.

In summary, the present invention provides a method for manufacturing a patterned electrode. The method mixes graphene, PEDOT:PSS, and photoresist together to form graphene/PEDOT:PSS photoresist having electrical conduction capability and using the graphene/PEDOT:PSS photoresist having electrical conduction capability to form a patterned electrode. Compared to the existing techniques that uses an ITO material, the material costs of graphene and PEDOT:PSS are greatly reduced. Further, by using the graphene/PEDOT:PSS photoresist that is electrically conductive to directly conduct a patterning operation, compared to the existing techniques, an operation of coating positive photoresist is saved so that the manufacturing time and manufacturing cost can be both reduced. Further, the present invention also provides a manufacturing method of a liquid crystal display panel. The method uses a graphene/PEDOT:PSS mixture solution to make a complete first electrode covering an entire surface and uses a graphene/PEDOT:PSS photoresist that is electrically conductive to make a patterned second electrode, so as to reduce manufacturing cost, increase manufacturing efficiency, and achieve multi-domain alignment. The present invention further provides a liquid crystal display panel. The liquid crystal display panel may achieve multi-domain alignment, reduce the cost of a liquid crystal display panel, and increase product competition power.

Based on the description given above, those having ordinary skills of the art may easily contemplate various changes and modifications of the technical solution and technical ideas of the present invention and all these changes and modifications are considered within the protection scope of right for the present invention.

What is claimed is:

1. A method for manufacturing a patterned electrode, comprising the following steps:
(1) providing a graphene aqueous solution and a PEDOT:PSS (poly(3,4-ethylenedioxythiophene):polystyrene sulfonate) solution and mixing the graphene aqueous solution and the PEDOT:PSS solution at a predetermined ratio to form a graphene/PEDOT:PSS mixture solution;
(2) providing photoresist and mixing the graphene/PEDOT:PSS mixture solution and the photoresist at a predetermined ratio, followed by stirring, to form graphene/PEDOT:PSS photoresist that has electrical conduction capability; and
(3) providing a substrate and coating the graphene/PEDOT:PSS photoresist formed in step (2) on the substrate, and using a mask having a predetermined shape to subject the graphene/PEDOT:PSS photoresist coated on the substrate to exposure, followed by development with a developing solution and baking to form a patterned electrode.

2. The method for manufacturing a patterned electrode as claimed in claim 1, wherein in step (1), a mass percentage of graphene contained in the graphene aqueous solution is 1 wt %-99 wt % and a mass percentage of PEDOT:PSS contained in the PEDOT:PSS solution is 1 wt %-99 wt %; and
the graphene aqueous solution and the PEDOT:PSS solution are mixed at a mass ratio of 1:5-1:100.

3. The method for manufacturing a patterned electrode as claimed in claim 2, wherein in step (2), the graphene/PEDOT:PSS mixture solution and the photoresist are mixed at a mass ratio of 1:1-1:50; and the photoresist comprises a photosensitizer, resin, and a solvent, wherein the photosensitizer, the resin, and the solvent have a mass ratio of 5:20:75.

4. The method for manufacturing a patterned electrode as claimed in claim 1, wherein in step (3), coating the graphene/PEDOT:PSS photoresist is achieved with slit coating; the developing solution comprises a potassium hydroxide solution and a mass percentage of potassium hydroxide in the potassium hydroxide solution is 0.04 wt %; and baking temperature is 230° C. and baking time is 10 min.

5. A manufacturing method of a liquid crystal display panel, comprising the following steps:
(1) providing a graphene aqueous solution and a PEDOT:PSS solution and mixing the graphene aqueous solution and the PEDOT:PSS solution at a predetermined ratio to form a graphene/PEDOT:PSS mixture solution;
(2) providing photoresist and mixing the graphene/PEDOT:PSS mixture solution and the photoresist at a predetermined ratio, followed by stirring, to form graphene/PEDOT:PSS photoresist that has electrical conduction capability;
(3) providing a color filter substrate, coating the graphene/PEDOT:PSS mixture solution formed in step (1) on the color filter substrate in order to form a first electrode on the color filter substrate after baking, wherein the first electrode is a complete electrode covering an entire surface and having a uniform thickness and is continuous and non-interrupted, and forming a first liquid crystal alignment layer on the first electrode;
(4) providing an array substrate and coating the graphene/PEDOT:PSS photoresist formed in step (2) on the array substrate, using a mask having a predetermined shape to subject the graphene/PEDOT:PSS photoresist coated on the array substrate to exposure, followed by development with a developing solution and baking to form a patterned second electrode, and forming a second liquid crystal alignment layer on the second electrode; and
(5) assembling the color filter substrate and the array substrate together to have the first liquid crystal alignment layer and the second liquid crystal alignment layer opposite to each other and filling liquid crystal between the first liquid crystal alignment layer and the second liquid crystal alignment layer to form a liquid crystal layer so as to form a liquid crystal display panel.

6. The manufacturing method of a liquid crystal display panel as claimed in claim 5, wherein in step (1), a mass percentage of graphene contained in the graphene aqueous solution is 1 wt %-99 wt % and a mass percentage of PEDOT:PSS contained in the PEDOT:PSS solution is 1 wt %-99 wt %; and
the graphene aqueous solution and the PEDOT:PSS solution are mixed at a mass ratio of 1:5-1:100.

7. The manufacturing method of a liquid crystal display panel as claimed in claim 6, wherein in step (2), the graphene/PEDOT:PSS mixture solution and the photoresist are mixed at a mass ratio of 1:1-1:50; and the photoresist comprises a photosensitizer, resin, and a solvent, wherein the photosensitizer, the resin, and the solvent have a mass ratio of 5:20:75.

8. The manufacturing method of a liquid crystal display panel as claimed in claim 5, wherein in step (3), coating the graphene/PEDOT:PSS mixture solution is achieved with a spin coating process and the spin coating process comprises: first conducting spin coating at a rotational speed of 500 rpm for 10 s and then conducting spin coating at a rotational speed of 800 rpm for 20 s; and baking temperature is 120° C. and baking time is 10 m in.

9. The manufacturing method of a liquid crystal display panel as claimed in claim 5, wherein in step (4), coating the graphene/PEDOT:PSS photoresist is achieved with an operation of slit coating, spin coating, or spray coating; the developing solution comprises a potassium hydroxide solution and a mass percentage of potassium hydroxide in the potassium hydroxide solution is 0.04 wt %; and baking temperature is 230° C. and baking time is 10 min.

10. A liquid crystal display panel, comprising: a color filter substrate, an array substrate opposite to the color filter substrate, a first electrode arranged on one side of the color filter substrate that is adjacent to the array substrate, a first liquid crystal alignment layer arranged on the first electrode, a second electrode formed on the array substrate, a second liquid crystal alignment layer arranged on the second electrode, and a liquid crystal layer interposed between the first and second liquid crystal alignment layer;
wherein the second electrode is a patterned electrode and the first electrode is a complete electrode covering an entire surface and having a uniform thickness and is continuous and non-interrupted;
the first electrode is formed of a material comprising a mixture of graphene and PEDOT:PSS; and
the second electrode is formed of a material comprising a mixture of graphene, PEDOT:PSS, and photoresist.
